(19) United States
(12) Patent Application Publication
(10) Pub. No.: US 2015/0186896 A1
(43) Pub. Date: Jul. 2, 2015

(54) SYSTEM AND METHOD OF RELATIME INPSECTION OF REMOTE FACILITY

(71) Applicant: David Mark Vass, Calgary (CA)

(72) Inventor: David Mark Vass, Calgary (CA)

(73) Assignee: Oilfield Inspection App Inc., Calgary (CA)

(21) Appl. No.: 14/142,522

(22) Filed: Dec. 27, 2013

(51) Int. Cl. G06Q 30/00; G06Q 10/10

(52) U.S. Cl. CPC G06Q 30/018; G06Q 10/10

(57) ABSTRACT

Disclosed are methods of communicating information regarding a problem with a location, the method comprising: providing a form on a mobile device, electronically filling the form on the mobile device at a first location; noting a problem about the first location on the form; and electronically flagging the form.

### FIELD OF THE INVENTION

The present invention relates to an app for inspection of remote locations and oilfields, more specifically, to a mobile app for reporting inspection information to appropriate authorities and administration staff in a timely manner.

### BACKGROUND OF THE DISCLOSURE

Certain remote facilities, such as oil fields, factories, warehouses, laboratories, farms, etc., are routinely inspected by field agents. These agents fill out forms to record their inspections. Invariably, the forms are filled out at the base office hours, and sometimes days, after the inspection was completed. During this lapse time, critical information may be lost and certain hazardous situations, which may require immediate attention, may not be communicated to the appropriate authorities in a timely fashion.

Accordingly, a need exists in the art for the preparation and submission of inspection reports in real time.

### SUMMARY OF THE INVENTION

Disclosed are methods of communicating information regarding a problem with a location, the method comprising: providing a form on a mobile device, electronically filling the form on the mobile device at a first location; noting a problem about the first location on the form; and electronically flagging the form.

### BRIEF DESCRIPTION OF THE DRAWINGS

FIG. 1 depicts a form for inspection of a remote location/oilfield in accordance with a disclosed embodiment.

FIG. 2 depicts an administration form for inspection of an remote location/oilfield in accordance with a disclosed embodiment.

FIGS. 3a-3e depicts various customized forms associated with inspection of an remote location/oilfield in accordance with a disclosed embodiment.

FIG. 4 depicts a real time form submission process in accordance with a disclosed embodiment.

### DETAILED DESCRIPTION OF THE EMBODIMENTS

In the following discussion, numerous specific details are set forth to provide a thorough understanding of the present invention. However, it will be obvious to those skilled in the art that the present invention may be practiced without such specific details.

Throughout the present disclosure, “app” refers to an application that is downloaded on a mobile device and can run functions on that mobile device. A “mobile device” refers to a smart phone, such as an Apple® iPhone®, Droid® RAZR®, Samsung® Galaxy®, Blackberry®, and the like, or a smart tablet, such as an Apple® iPad, Asus® Transformer Pad, Nokia® Lumia®, and the like.

Provided herein is a communication environment, which provides the context for the methods disclosed herein. In some embodiments, the communication environment includes a cloud computing environment, which may include cloud applications, cloud platforms, and cloud infrastructure. The cloud computing environment communicates with a mobile device, which may include one or more mobile app(s) for the inspection of a remote location, e.g., a factory, a warehouse, a processing plant, an oilfield, a mine, a laboratory, and the like.

The inspection may be for planning preventive maintenance, compliance with regulatory procedures, or pollution control or for some other reason. In one embodiment, the inspection is for a routine inspection. In another embodiment, the inspection is for surprise inspection of the remote location by a regulatory or compliance authority. It is noted that random inspections are also performed to ensure uninterrupted operation of the remote location.

It is known in the art that common inspections of a remote location includes several processes, such as filing a report or an online form, capturing remote location images, inspection of hazardous zones, notes, compliance procedure for various equipments installed at the location, and the like. Currently, inspectors note issues with an inspected site on their inspection forms and then forward the forms to the base of operations, e.g., the headquarters or a field office. The supervisors at the base sift through the various forms and then identify those in which an issue is identified for further processing. The sifting may take place hours or days after the inspection was completed. This delay causes a dangerous situation to persist or to become worse. The methods disclose herein allow the inspector to flag an electronically-filled report to be flagged in such a way that the supervisor can immediately be notified, or that the supervisor can very quickly sift through the multiple reports and identify the flagged ones for immediate review. Further, the electronic filled forms disclosed herein allow the field inspector to attach a separate electronic filled form to their main form, in which an issue is identified and the details are communicated. The methods disclosed herein take advantage of electronic communications to provide for a quick and complete response to an identified problem in an inspected remote area.

In one aspect, the methods and apps disclosed herein provide for the preparation of the forms and reports using a mobile device in real time during the inspection. In some embodiments, the above-mentioned procedures are translated into one or more fillable form(s) and developed into an application, which is then installed on the mobile device. In some embodiments, a mobile app having a provision to capture all the information or data for the inspection of the remote location is provided.

In some embodiments, the application may be a mobile app, a web app, or an ordinary app for web services that can be configured on any type of computing device. Throughout the present disclosure, the app may be referred to as mobile app, inspection app, or simply an app.

In certain embodiments, the computing device is a tablet, a mobile phone, a hand held computing devices, or any other type of computing device. In another embodiment, a web based application is developed, which is installed on a laptop, a mini-laptop, a desktop computer, or some other type of computing device.

In some embodiments, the inspection app includes one or more forms. For example, in one embodiment, a login form is used for authentication of a user, such as, for example a worker, a field agent, and/or an inspector. In some embodiments, the authentication includes identifying privileges associated with the user for accessing the archived information, data, images, documents, notes and the like, residing on the cloud server in the cloud computing environment. In certain embodiments, the user is a representative of the company owning the remote location, a representative of a regulatory or compliance authority or any other person. Thus, for example, some users, for example the field agent conducting the inspection, may have “write-only” privileges for the forms the user is accessing at the moment. These users will not be able to access forms that other field agents have prepared in the past or are preparing at the time. A compliance authority may have “read-only” privileges, such as that the user may not change any of the data entered on a particular form, but may view the form in its entirety, or in part. A supervisor may have read and write privileges such as the supervisor may review all or some of the forms and then make corrections on the forms.

In some embodiments, the mobile device includes a communication function to communicate with a base station. In addition, in certain embodiments the mobile device includes additional circuitry to process information and data. A storage facility in the form of ROM, RAM, and flash card may be configured in the mobile device along with a processor enabled to process encoded instruction. An operating system is provided to control various operation of the mobile device.

In some embodiments, communication between the mobile app and the cloud server may take place in an encrypted mode. For example, all communication may be exchanged using SSL technology. In an alternate embodiment, encryption may be applied to specific type of information. For example, in one implementation, only the reports, documents and notes may be encrypted, whereas as images may be exchanges in a non-encrypted mode.

Thus, in one aspect, the processes and the apps disclosed herein comprise procedural forms that are used to assure the quality of, for example, a site inspection, whereby the user, e.g., the inspector, follows a standard operating procedure (SOP) for the inspection and every step of the procedure is followed without the inspector having skipped any steps. In these embodiments, the app provides a form for the particular inspection being performed. The form contains appropriate data entry points for every step in the SOP. Each step has a minimum time required for its performance. The minimum time requirement is calculated based on the inspection firm's knowledge of the procedure. The inspector checks in at the start of the inspection process and moves to the first step in the SOP. The app time stamps the start of the first step. The inspector conducts the first step of the inspection procedure and enters the results on the app and checks out of the first step and checks in at the next step of the inspection in the SOP. The app time stamps the check out and calculates the amount of time it took the inspector to complete the first step, and whether the amount of time satisfied the minimum time requirement. The app uses the GPS function of the inspector's mobile device to record the location of the inspector when the first step was performed. This procedure is performed for every step of the SOP. Accordingly, the inspector cannot skip a step of inspection.

As mentioned above, in one embodiment, the disclosed app provides for a process for the user to check in to ensure safety and/or measure the productivity of the user. The user, e.g., a filed agent or an inspector, may check-in in real time and the administrative office may monitor the check-in information for a variety of purposes. In one embodiment, the check-in information may be utilized to determine the safety of the user or the associated staff. In another embodiment, the check-in information may be utilized to monitor the productivity of the user.

In some embodiments, the workflow is implemented in the mobile app and various processes and forms are developed to achieve an optimized workflow. Furthermore, a check-in and check-out facility is integrated into the mobile app for administration and monitoring purposes.

In certain embodiments, the administrative staff can log into the central admin panel that is available on a desktop or laptop computer. The administrative staff may be able to view number of the workers that have checked in on a particular day. Alternatively, the administrative staff may be able to inquire about the list of all the workers who have checked in at a remote location on a particular day or time.

In certain embodiments, the check-in function is associated with an alert function that sends an alert to the administrative staff if one or more workers do not check out before their maximum allotted time for check-out. The alert notification may be sent via email or as a text message. In some embodiments, a user may click an emergency button on the inspection app to declare an emergency at remote location.

In another embodiment, the alert facility may be utilized for alerting one or more users of an emergency at a particular site. In these embodiments, the app alerts those individuals who have checked in at the particular site. The app may also notify one or more workers who have checked-in of the procedures to be followed under the current emergency situation.

In some embodiments, the check-in feature is used for monitoring work productivity. Based on the check-in and check-out times the user or the administration staff are able to ascertain the time required for the inspection of site or for performing a certain task at the site.

During the inspection process, the user, e.g., an inspector, may identify an issue with the inspected site. The issue may be the identification of an area that requires repairs, modifications, or revamping, or the identification of a dangerous situation that requires immediate attention, for example a fire hazard, an explosion hazard, a health hazard, or a worker safety hazard. The presently disclosed app allows for the user to quickly flag the form and identify the issue.

In some embodiments, the app provides a provision to mark an issue as a critical issue. Such issues require immediate attention. An alert may be forwarded to the specific authorities or administrative staff to alert them of the immediate attention required on the critical issue. The inspection app is configured to facilitate the management of the communication and responsiveness between inspection, administration, construction, safety, field, and operations teams in an optimized manner, by notifying the relevant individuals immediately. Additionally, in some embodiments the inspection app is configured to ensure that responsibility is fixed at all levels in the workflow such that potential non-compliance can be easily identified at every stage of the workflow.

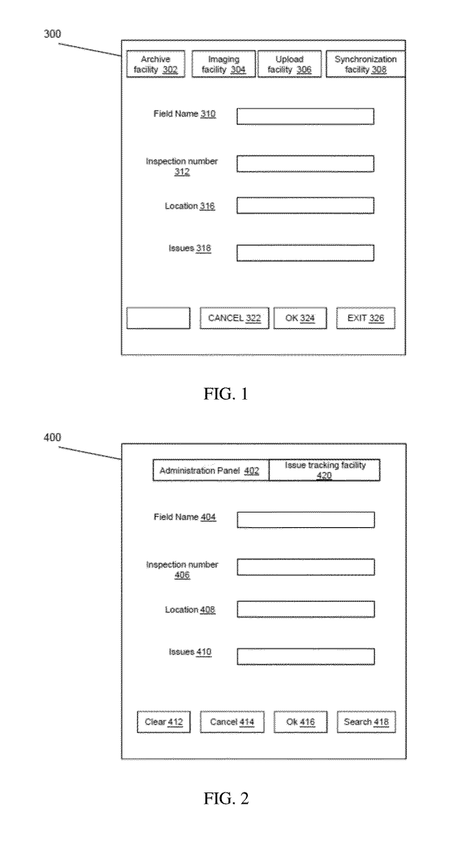

FIG. 1 provides an example of a form 300 for inspection of remote location and/or oilfield. The illustrated form includes an archive facility 302, which connects to the cloud server to identify any archived documents or files associated with the oilfield under inspection. In some embodiments, a user is able to search documents or files for reference or for attaching with the current form currently being filed.

The illustrated form 300 also includes an imaging facility 304. The imaging facility 304 is associated with the camera of the mobile device. Images captured from the camera of the mobile device may be edited using the imaging facility. The imaging facility allows the user to select images that are attached with the form before uploading to the cloud server.

The illustrated form 300 also includes an upload facility 306, which facilitates the uploading of documents, images, notes and the like to the cloud server, when the form is submitted. The upload facility 306 includes a provision of compressing the files, documents, images, and the like in order to reduce the upload size.

A synchronization facility 308 ensures that the illustrated form 300 is automatically saved on the cloud server at certain time intervals. For example, the form updates the cloud server every 10 milliseconds. Such provisioning ensures that information filled in the form 300 is continuously saved on the cloud server and is always up to date. In an alternative embodiment, the information filled in the form 300 is cached locally on the mobile device before being updated on the cloud server.

In some embodiments, a number of additional fields, such as filed name 310, inspection number 312, location 316, and issues 318, are provided on the illustrated form 300. The user fills in the required information related to inspection of the remote location/oilfield. After filling in the required information, the form 300 may be submitted by clicking on the OK button 324. A CLEAR button 320 is provided that allows the user to clear the most recently entered text. A CANCEL button 322 allows the user to exit the form 300 but not the inspection app. An EXIT button 326 allows the user to exit the mobile app 202.

It is understood that the illustrated form 300 is only one example of a form that can be used in the present methods. Other forms can achieve the same or similar results without having one or some of the functionalities described above, or having additional functionalities not disclosed herein.

The inspection app includes various validations to ensure correctness of the data in the forms and to further ensure that no data is lost or incorrectly entered on the cloud server. In addition, in some embodiments the inspection app is configured to ensure that no issues related to the current inspection are left unaddressed. Furthermore, the inspection app may include various algorithms that guarantee that issues identified by the user are always addressed.

In another aspect, disclosed herein is a process for real time issue tracking as well as collaboratively solving an issue. After the user submits an issue and related data or information to the data repository, the software processes may register the information and may create one or more issues from it. Each issue may be automatically assigned an issue tracking number and an issue identification number. The issue may be tracked by the software embedded in the cloud server or using a software in a client-server environment. An issue may also be assigned a priority, which may depend upon the severity of the issue. The issues may be collectively brainstormed or collaboratively solved via an online community, which may include members, experts, engineers, compliance agencies or some other entities associated with the issue and capable of providing a solution to the issue. Once, an adequate solution has been identified, the user may take it into consideration expert advice, or may appropriately implement it.

In an embodiment the inspection app is designed to allow the user to utilize the mobile device at the remote location to upload new files to an administration panel and to the cloud server. In one embodiment, the administration panel is housed on the cloud server as a form or an application.

FIG. 2 illustrates an example of an administration form 400. In some embodiments, the administration form comprises an administration panel 402. The illustrated administration form 400 also includes an issue tracking facility 420, which allows for the tracking and monitoring of issues. An issue may be open or closed depending on its state. Similarly, the user may reopen a closed issue. Issue opening and tracking is well known in the art. The administration form 400 also includes other fields such as field name 404, inspection number 406, location 408, and issue 410. The textboxes associated with these fields may be used for submission of information using OK button 416. Alternatively, the textboxes associated with fields may be utilized for searching required information using search button 418. A clear button 412 may clear off the information previously entered into the textboxes. Likewise, the cancel button 414 may cancel the submission of information to the cloud server.

In certain embodiments, the issue tracking facility 420 allows fixing priority to the issues. The priority associated with the issue may be selected from a high, low, or medium priority, or be assigned a number on a scale, for example from 0-10. The issues queue may be processed according to the priority associated with the issue. In an example, the issues with the highest priority may be processed first by the server whereas issues with a lower priority may be processed after all the issues with high and medium priority have been addressed.

In one aspect, disclosed herein is a process for real time form submission of data or information associated with the inspection app. In some embodiments, the process of submission includes the step of validation of information by the user. In some embodiments, the user may submit the data using an XML file, which is generated when the user submits the form. The data is stored securely on a cloud server. In another embodiment, the data is encrypted and stored on a client server environment. In yet another embodiment, the data is stored on the Intranet server of an organization. In some embodiments, the cloud or the server includes a process for user validation. User validation may be performed by utilizing a mobile device, a desktop computer, or some other type of communication device by entering a user name and a password. Once the user is validated, the data is made available. The data may be accessible at any time from the data repository. In an embodiment, the data may be backed-up or archived immediately after it is uploaded or a form is submitted to the data repository.

In certain embodiments, the inspection app may be configured to sync the data in real-time with a back-end server. In this embodiment, the back end server may be hosted at a remote location or may be hosted locally in the company building. The back end server may be accessible from a desktop computer via LAN, WAN internet or a wireless connection.

In certain embodiments, inspectors or field agents have the ability to upload their files from the remote location, which allows administrators, construction managers, or other staff requiring inspection information to access all the data in real-time irrespective of their location.

In some embodiments, a chat facility is provided between the user and the administrative staff.

In some embodiments, the data is saved and synced later at appropriate time. This may be due to unavailability of the mobile signal at the remote location or oilfield periodically. By way of example and not limitation, in one embodiment all data may be logged, tracked, and organized in the back-end server, which is backed up at regular time periods on a backup server.

In some embodiments, a first user uploads a file in the account of a second user for drawing the attention of the second user to a critical issue that requires immediate attention. In another embodiment, a collaborative file sharing facility allows the one or more user to work collaboratively on a single file. The file sharing facility allows the users to edit, update, and modify a shared file in real time.

In another embodiment, the processes and the apps disclosed herein comprise frequency forms that are used to provide accountability for a particular task. For example, some companies require that a certain task, or example an inspection, take place on a regular basis and that the required forms be filled out each time the task is performed. In one embodiment, the presently disclosed app provides for a “To Do” list for a particular task, wherein the list comprises a list of the regularly scheduled tasks, e.g., inspections, to be performed, along with the dates for the performance of the task. If a task is not performed on the particular date or time that is noted on the list, the app will record that task as having not been performed and so notifies the administrative staff. The performer of the task is then held accountable to provide a reason for the missed performance.

In another embodiment, the processes and the apps disclosed herein comprise steps that allow supervisors to better organize and prioritize all the forms being submitted. The app provides the user, e.g., an inspector, with the opportunity to flag a form and attach an issue with the form. The supervisor can then quickly identify the problems with the particular inspection based on the recorded issues and determine the steps required to rectify the problem, without having to sift through all the forms. Thus, in some embodiments, the forms on the disclosed apps comprise the option for the user to flag it. If the form is flagged, then the user has the option to attach an issue. The user provides a reason for flagging the form. A reviewer of the form, for example a supervisor, obtains a list of the flagged forms at the supervisor's terminal (e.g., computer, mobile device, etc.). The reviewer then has the ability to read the reasoning for the flag, and if an issue is attached, to read the issue associated with the form without delay.

In some embodiments, the reviewer of the form receives an electronic signal that a flagged form has been submitted. The electronic signal can comprise a text message, an alert signal on the reviewer's computer or mobile device, an e-mail message, and the like.

In some embodiments, the flagged forms are collated in a separate electronic folder than the unflagged forms. In these embodiments, the reviewer of the forms can quickly and easily access all the flagged forms by accessing the separate folder.

In other embodiments, the forms are organized in a list. Each flagged form is clearly marked on the list by an indicator, such as a red flag, a highlight, and the like. The reviewer can scan the list of the forms and quickly identify the flagged forms. In certain embodiments, the flagged forms appear on top of the list and the unflagged forms below the flagged forms. In some embodiments, the forms are listed in the order they are received, whereas in other embodiments, the forms are listed in the order of priority.

In certain embodiments, the submissions of the form utilizes SSL, or another type of, encryption technique.

In certain embodiments, the data or information stored in the cloud server is backed up at fixed time intervals to ensure enhanced security of the information.

In some embodiments, the form such as form 300 or form 400 is customizable according to the requirements of an organization. The customization feature allows users to reorganize the form as per requirement and workflow.

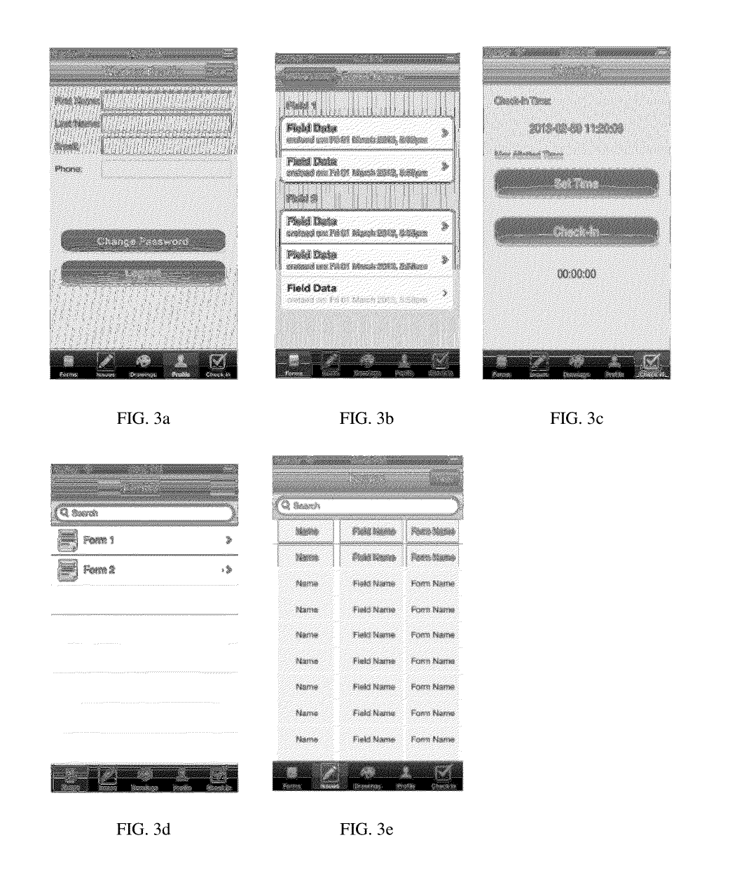

FIGS. 3a-3e illustrate examples of various screens associated with an embodiment of the oil inspection app. For example, in the screen of FIG. 3a, the user enters his/her profile. The screen of FIG. 3b shows an example of how the field data is entered. FIG. 3c shows an example of a check-in screen. In the screen of FIG. 3d, the user chooses the particular form that the user is going to use at that particular time. FIG. 3e shows an example of a screen where the various issues associated with, for example, an inspection are entered.

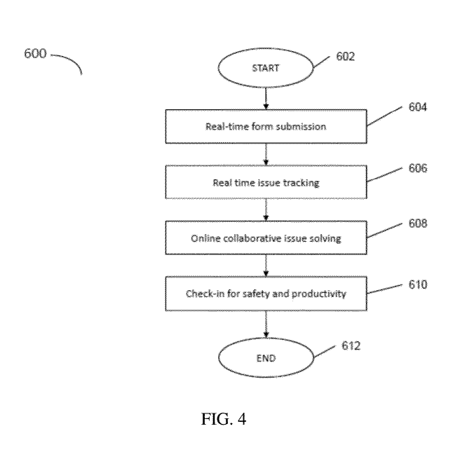

Referring to FIG. 4, a process 600 associated with an inspection app for tracking and solving submitted issues is illustrated in an embodiment of the invention. It is noted that process 600 is merely for illustrative purpose. An actual process may include additional or fewer steps in other embodiments. Furthermore, those skilled in the art understand that the process 600 provides detailed information for safety of field agents regarding operational efficiencies, emergencies, production planning, preventive maintenance and some other type of information.

In the embodiment of FIG. 4, the process 600 starts at 602 and immediately moves to step 604, where the user submits information about operational effectiveness of the oil field under inspection. In some embodiments, the oilfield is currently under inspection, whereas in another embodiment, the oilfield was already inspected by the user. The report of the inspection is submitted in a form provided by the inspection app. The form highlights one or more issues related to operation of the oilfield. A field engineer may submit these issues to the inspection app for obtaining appropriate solutions or suggest remedial action. Each issue may be associated with an issue identification number for tracking purposes. At step 606, the process 600 tracks an issue using the issue tracking identification number. The issues may be forwarded or shared with an online community, which may include members, experts, engineers, compliance agencies or other entities associated with the issue and capable of providing a solution thereto. In one embodiment, the issue may be shared with an organization. In another embodiment, the issue may be shared within the organization and/or outside technology experts. In yet another embodiment, the filed agent may assign the issue to members within the organization and outside experts. At step 608, the issue may be brainstormed or collaboratively solved by the online community members. The collaborative tools for brainstorming on the issue may include chat software, document collaboration software, online video conferencing software and the like. At step 610, the results of the solutions/remedial action provided by the online community may be recorded by the filed agent. For example, the solution may warrant halting the operation of the remote oilfield or implementation of a standard operating procedure (SOP) in anticipation of an emergency. Thus, the present methods provide the implementation of a disaster aversion and management solution in a timely manner to avoid accidents. Collective knowledge ensures that corrective action can be taken in a timely manner and collaborative tools ensure quick response to issue resolution. The process 600 may end at step 612 after the issue has been successfully resolved. In another embodiment, the process 600 may start again to address other pending issues. This may continue until all the issues have been addressed.

What is claimed is:

1. A method of communicating information regarding a problem with a location, the method comprising:
providing a form on a mobile device,
electronically filling the form on the mobile device at a first location;
noting a problem about the first location on the form; and
electronically flagging the form.

2. The method of claim 1, wherein the first location is an inspected site.

3. The method of claim 1, wherein the first location is a remote site.

4. The method of claim 1, further comprising automatically notifying an individual at a second location of the flagged form.

5. The method of claim 4, wherein the individual at the second location accesses the flagged form prior to accessing any unflagged forms.

6. The method of claim 1, further comprising attaching a second form to the electronically filled form, wherein in the second form the problem with the first location is described.

7. The method of claim 4, wherein the flagged forms are collated in a different electronic folder than any unflagged form.

8. The method of claim 4, wherein the flagged forms are listed in the order they are received.

9. The method of claim 1, further comprising assigning a priority level to the flagged forms.

10. The method of claim 9, wherein the priority is selected selected from a high, low, or medium priority.

11. The method of claim 9, wherein the form is assigned a priority number on a scale from 0-10, with 0 being low priority and 10 being high priority.

12. The method of claim 9, wherein the flagged forms are listed in an order of priority.
